(19) United States
(12) Patent Application Publication
(10) Pub. No.: US 2018/0315131 A1
(43) Pub. Date: Nov. 1, 2018

(54) USER-AWARE INTERVIEW ENGINE

(71) Applicant: HRB Innovations, Inc., Las Vegas, NV (US)

(72) Inventors: Pendra Peh, Olathe, KS (US); Vinayak Kamat, Overland Park, KS (US); Jason Houseworth, Olathe, KS (US)

(21) Appl. No.: 15/581,564

(22) Filed: Apr. 28, 2017

(51) Int. Cl. G06Q 40/00; G06Q 30/00; H04N 5/225; G06K 9/00; H04M 1/725; G10L 25/63

(52) U.S. Cl. CPC G06Q 40/123; G06Q 30/016; H04N 5/2257; G06K 9/00302; H04M 2250/52; G06K 9/00255; G10L 25/63; H04M 2250/12; H04M 1/72561

(57) ABSTRACT

Media, method and system for automatically assisting a user with a complex task. Embodiments of the invention facilitate a user in completing the complex task. However, the user may have difficulty with certain subtasks of the complex task, or become confused by the instructions for carrying out the subtask. Sensors integrated into the user's device can observe the user and detect user sentiments such as confusion, frustration, or anger. If such a sentiment is detected, embodiments of the invention can automatically act to remediate the difficulty by, for example, connecting the user with an agent who can provide the user with additional guidance.

### BACKGROUND

### 1. Field

Embodiments of the invention generally relate to user interfaces and, more particularly, to user interfaces that are aware of the user and can provide additional assistance when the user experiences difficulties.

### 2. Related Art

Traditionally, user interfaces for performing complex tasks have featured “help” functions to provide additional guidance (by providing additional, more detailed instructions or connecting the user to a help desk agent) to a user when they request it. However, a human assistant still has the advantage that they can empathize with the user and proactively offer help when the user is struggling even if the user does not think to ask for help, or does not realize that help is available.

Accordingly, it would be advantageous to create an assistant for completing complex tasks that can duplicate this ability to detect when the user is struggling, needs guidance or help, is about to make an error, or likely has made an error and has to re-do a task. Having the ability to detect such conditions can allow the assistant to provide additional guidance (such as giving the user extra help or having a human support representative reach out to them to give appropriate guidance at just the right times) without any effort to report the issue from the users. Mobile devices that might be used to provide the user with instructions also incorporate a wide variety of sensors that can be used to analyze user sentiment. As such, what is needed is a user-aware interview engine that can take advantage of sensors integrated in mobile devices to detect when a user is struggling and proactively provide additional help.

### SUMMARY

Embodiments of the invention address the above-described need by providing for a user-aware assistant for performing complex tasks. In particular, in a first embodiment, the invention includes one or more computer-storage media storing computer-executable instructions that, when executed by a processor, perform a method of assisting a user with a complex task, the method comprising the steps of determining a subtask of a complex task for the user to complete, presenting the subtask to the user on a smartphone, receiving input from one or more sensors incorporated into the smartphone, determining, on the basis of the input form the one or more sensors, a sentiment of the user, and based at least on the sentiment of the user, automatically connecting the user with an agent to assist the user with the subtask.

In a second embodiment, the invention includes a method of assisting a user with a complex task, comprising the steps of presenting, to the user and on a mobile device associated with the user, an indication of a subtask of the complex task, receiving, from a sensor communicatively coupled to the mobile device, data about the user, determining, based on the data about the user, a sentiment of user while performing the subtask, and based at least in part on the sentiment of the user, providing the user with additional guidance in completing the subtask.

In a third invention, the invention includes a system for assisting a user in completing a complex tax, comprising a server and a mobile device of the user, wherein the mobile device incorporates a sensor configured to gather data about the user and wherein the mobile device is programmed to present a subtask of a complex task to the user, receive data from the sensor about the user, transmit the data received from the sensor to the server, wherein the server is programmed to receive the data received from the sensor from the mobile device, determine, based at least in part on the data received from the sensor, a sentiment for the user while performing the subtask, and automatically establish, via the mobile device, communication between the user and an agent tasked with assisting the user with the complex task.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 depicts an exemplary hardware platform for certain embodiments of the invention;

FIG. 2 depicts a block diagram illustrating an exemplary environment suitable for operation of embodiments of the environment; and

FIG. 3 depicts a flowchart illustrating the operation of a method in accordance with embodiments of the invention.

The drawing figures do not limit the invention to the specific embodiments disclosed and described herein. The drawings are not necessarily to scale, emphasis instead being placed upon clearly illustrating the principles of the invention.

### DETAILED DESCRIPTION

At a high level, embodiments of the invention utilize sensors integrated into a user device to determine when the user is struggling with a particular subtask of a complex task. When user difficulty is encountered, the system proactively remediates the issue by, for example, having a human agent reach out to contact the user to offer help.

The subject matter of embodiments of the invention is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be obvious to one skilled in the art, and are intended to be captured within the scope of the claimed invention. Terms should not be interpreted as implying any particular ordering of various steps described unless the order of individual steps is explicitly described.

The following detailed description of embodiments of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of embodiments of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment” “an embodiment”, or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments, but is not necessarily included. Thus, the technology can include a variety of combinations and/or integrations of the embodiments described herein.

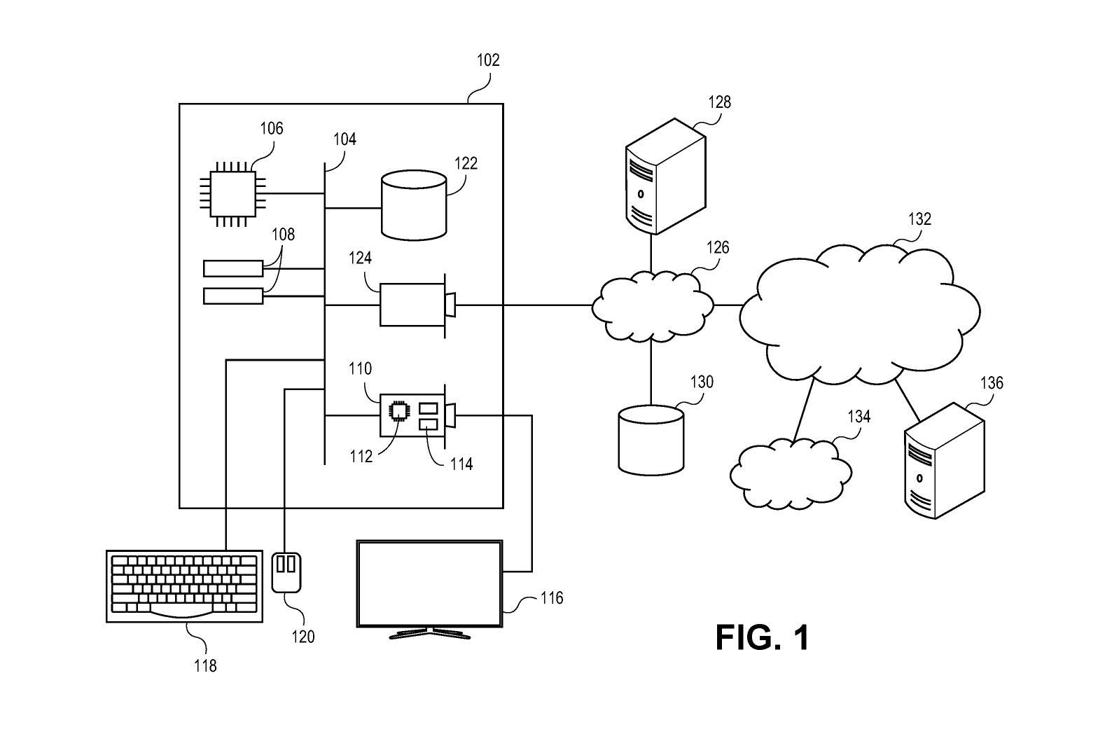

Turning first to FIG. 1, an exemplary hardware platform for certain embodiments of the invention is depicted. Computer 102 can be a desktop computer, a laptop computer, a server computer, a mobile device such as a smartphone or tablet, or any other form factor of general- or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple busses or components may communicate with each other directly. Connected to system bus 104 is central processing unit (CPU) 106. Also attached to system bus 104 are one or more random-access memory (RAM) modules. Also attached to system bus 104 is graphics card 110. In some embodiments, graphics card 104 may not be a physically separate card, but rather may be integrated into the motherboard or the CPU 106. In some embodiments, graphics card 110 has a separate graphics-processing unit (GPU) 112, which can be used for graphics processing or for general purpose computing (GPGPU). Also on graphics card 110 is GPU memory 114. Connected (directly or indirectly) to graphics card 110 is display 116 for user interaction. In some embodiments no display is present, while in others it is integrated into computer 102. Similarly, peripherals such as keyboard 118 and mouse 120 are connected to system bus 104. Like display 116, these peripherals may be integrated into computer 102 or absent. Also connected to system bus 104 is local storage 122, which may be any form of computer-readable media, and may be internally installed in computer 102 or externally and removeably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-usable instructions, data structures, program modules, and other data representations.

Finally, network interface card (NIC) 124 is also attached to system bus 104 and allows computer 102 to communicate over a network such as network 126. NIC 124 can be any form of network interface known in the art, such as Ethernet, ATM, fiber, Bluetooth, or Wi-Fi (i.e., the IEEE 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132.

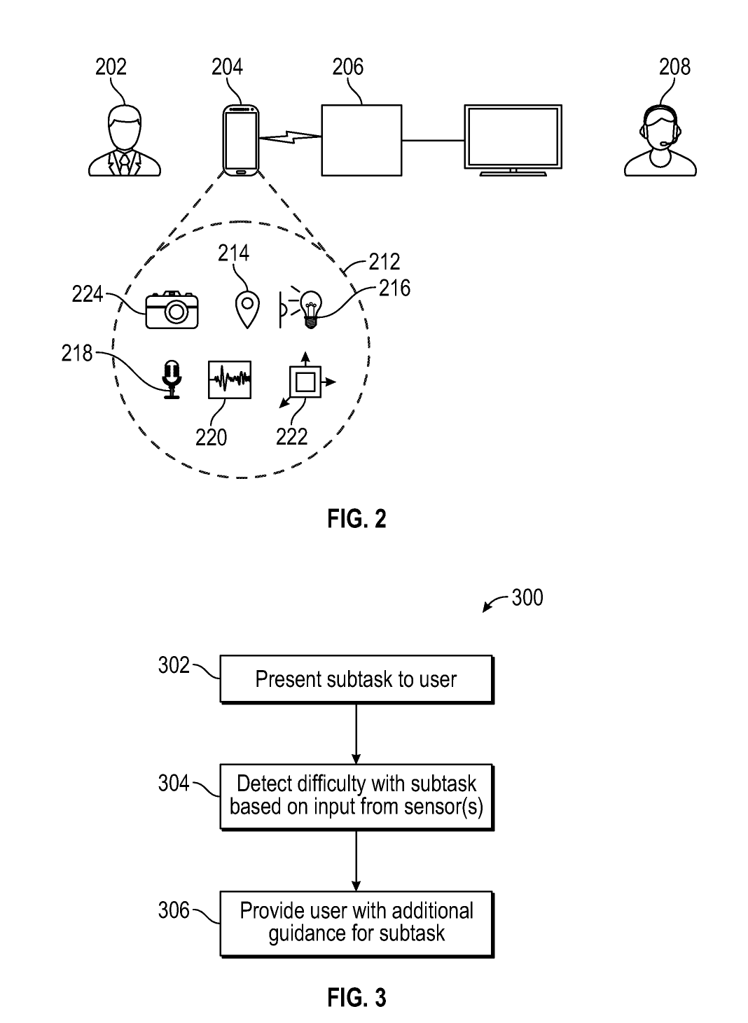

Turning now to FIG. 2, a block diagram illustrating an exemplary environment suitable for operation of embodiments of the environment is depicted and referred to generally by reference numeral 200. As depicted at a high level, user 202 is using mobile device 204 to complete a complex task. Mobile device 204, in turn, is in communication with server 206. Server 206 has one or more agents 210 who can aid user 202 with the complex task if needed. Embodiments of the invention allow mobile device 204 to use one or more sensors 212 to determine when user 202 is having difficulty with the complex task or is becoming frustrated with the task and proactively reach out to the user 202 to offer assistance by connecting them with agent 208.

Broadly speaking, user 202 can be engaged in any complex task. For example, user 202 can be shopping online for a new or used car. As another example, user 202 can be engaged in the process of completing a tax return, applying for a mortgage, applying for a job or college scholarship, or completing another complex form. As still another example, user 202 can be following instructions on device 202 to complete a task in the real world, such as repairing an automobile or appliance. One of skill in the art will appreciate that a user such as user 202 could be competing any complex task using mobile device 204, and embodiments of the invention are broadly contemplated as working with any such task.

As depicted, user 202 is using mobile device 204. However, any type of computing device with any set of sensors can also be employed. For example, in the example of tax preparation given above, a laptop with an integrated webcam can be used to detect the mood of user 202 based on their facial expression as they complete the tax interview. If analysis of the user's mood indicates that they are becoming confused or frustrated, they can be automatically connected to a tax professional to assist them with the process of completing the tax interview.

As described above, mobile device 204 has one or more sensors 212. Sensors 212 may be integrated into mobile device 204, externally connected to mobile device 204 or otherwise communicatively coupled to mobile device 204. In some embodiments, sensors 212 are not communicatively coupled to mobile device 204, but instead communicate directly and independently with server 206. For example, if user 202 is an employee working at their desk on a complex task, then one such sensor of sensors 212 could take the form of one or more wall-mounted IP cameras that observe user 202 for signs of confusion and cause server 206 to connect user 202 to agent 208.

Broadly speaking, any component that collects data about user 202, their environment, or mobile device 204 can be included in sensors 212. For example, a smartphone may include components such as such as location determining component 214, light sensor 216, microphone 218, biometric sensor 220, accelerometers 222, and front/rear-facing camera 224 that can act as sensors. Mobile device 204 may also include computer storage media (as described above with respect to FIG. 1) storing software (or “apps”) for facilitating the user's performance of the complex task and/or gathering data from sensors 212 to evaluate the sentiment of user 202 as they perform the task. In some embodiments, mobile device 204 collects the data from sensors 212 and performs the sentiment analysis. In other embodiments, mobile device 204 collects the data from sensors 212 and forwards it to server to perform the sentiment analysis. In still other embodiments, each sensor independently performs sentiment analysis and connects to server 206 if assistance from agent 208 is determined to be necessary. In yet other embodiments, sensors 212 forward data directly to server 206 to perform sentiment analysis.

Server 206 may be a single server used to process user submissions when performing the complex task and perform sentiment analysis, multiple servers operating in parallel to handle submissions and sentiment from multiple users such as user 202, or different servers to perform sentiment analysis and process user submissions. In some embodiments, agent 206 may be directly connected to server 206. In other embodiments, server 206 connects to a local computer or mobile device of agent 208. In some such embodiments, user 202 communicates with agent via server 206, while in other embodiments, agent 208 communicates directly with user 202 via the Internet, the telephone network, or in-app chat. Agent 208 may be a subject-matter expert in the complex task being performed by user 202, or may be a customer service agent with access to a help system.

Each sensor of sensors 212 may gather data used differently in performing sentiment analysis. Although the term “sentiment analysis” is used herein for the sake of brevity, sensors may also measure any aspect of the context in which the user is performing the complex task. For example, the user may be asked to photograph one or more documents for upload to server 206 as a part of the complex task. If location-determining component 214 (e.g., a Global-Positioning System (GPS) or GLONASS receiver) indicates that the user is in motion (e.g., driving in a car), the steps of the complex task involving photographing the documents for upload may be postponed until the user arrives at a home address associated with user 202. Conversely, if location-determining component 214 indicates that user 202 is at an address associated with a home contact of mobile device 204, subtasks involving documents likely to be stored at home can be prioritized. Broadly speaking, the effects of the sentiment analysis for each sensor may be different and may affect how the app facilitates user 202 in performing the complex task in different ways.

For example, certain subtasks may be easier to perform in particular contexts. Thus, as described above, location-determining component 214 may be used to defer a subtask of scanning or photographing a document until user 202 is not moving or until user 202 is at a particular location. Similarly, if light sensor 216 indicates that user 202 is in a low-light condition, subtasks involving photographing documents may be deferred until the conditions are more favorable to capturing a high-quality image of the documents. Some sensors may affect how the complex task is facilitated in multiple ways. For example, if light sensor 216 indicates a low-light condition, the system may infer that user 202 is resting and/or tired. As such, subtasks imposing a higher cognitive burden on user 202 may be deferred. Furthermore, each complex task may be affected differently by a particular context. For example, if the complex task is perform a particular automobile repair, then the above-described low-light condition as detected by light sensor 216 might instead cause the system to activate a flashlight function of mobile device 204 for user 202.

As another example, microphone 218 may be operable in a normal mode for speech-to-text data entry. If the microphone detects that the voice of user 202 includes one or more indicators of increased stress (e.g., shouting, altered vocal cadence, or profanity) the system can offer to connect user 202 to agent 208 to provide additional assistance with the current task. Alternatively, the system can suggest to user 202 that they end the current session and take a break. In other embodiments, microphone 218 can be used to detect audible indications of context even when it is not being used for text entry. For example, if microphone 218 captures multiple voices, that may be an indication that user 202 is distracted and the system can slow down the processing of the complex task and/or implement additional confirmations from user 202 to reduce the likelihood of a distraction-induced error.

In some embodiments, mobile device 204 may incorporate one or more biometric sensors 220, such as a heart-rate sensor or a skin conductivity sensor. Data from biometric sensors 220 can be used to determine a mood or stress level of user 202. For example, an elevated heart rate (as measured via a heart-rate sensor integrated into a smartphone) may indicate that the user is stressed or angry. Similarly, if the user is sweating (as measured by a skin-conductivity sensor), it may indicate an increased level of anxiety about the current sub task. In either of these cases, it may be appropriate to offer user 202 additional help in the form of assistance from agent 208 so as to reduce the level of frustration and/or anxiety.

Certain sensors may provide both sentiment data and context data for the task. For example, accelerometer 222 can provide information about the orientation and acceleration of mobile device 204. Thus, for example, in the example given above of performing a particular repair task, the orientation of the device can be used to automatically orient illustrations in the same orientation as they appear to user 202. At the same time, if the orientation and acceleration of mobile device is rapidly changing, it may indicate that user 202 has thrown or is shaking the device, which may be interpreted as a strong indication of frustration or dissatisfaction that should be addressed.

Another valuable source of context and sentiment data can be a front- or rear-facing camera 224 integrated into mobile device 204. For example, a front-facing camera (i.e., a camera oriented reciprocally to the display) will typically be positioned to capture the face of user 202. Based on imagery of the user's face, a mood for user 202 can be determined, and actions can be taken based on that mood. For example, if the user's expression indicates that the user is confused, then the system can offer to connect user 202 to agent 208. On the other hand, if the user's expression indicates that the user is frustrated or angry, then the system may postpone one or more remaining subtasks until user 202 is in a better mood.

As another example, a front-facing camera may be configured to track a gaze of user 202. Thus, for example, if user 202 spends an extended period of time looking at a document checklist, it may indicate that user 202 is confused or uncertain as to the documents to be collected. In such a scenario, additional help can be provided in the form of supplementary help text or an offer to connect to agent 208. On the other hand, if the user's gaze frequently leaves and returns to the display of mobile device 204, it may indicate that user 202 is distracted, and additional care should be taken to avoid mistakes.

A rear-facing camera (i.e., a camera oriented in the same direction as the gaze of a user viewing the screen) may also provide context for the task. For example, in the example where user 202 is performing an automobile repair task, the rear-facing camera can determine which steps of a checklist have been completed (e.g., whether a particular bolt has been removed). Similarly, orientation information derived from accelerometer 222 and imagery captured from rear-facing camera 224 can be combined to generate an augmented reality display on the display of mobile device 204 to assist user 202 in completing the task. Alternatively, a rear-facing camera, when used to capture images of documents to upload, can perform text-recognition on the captured image to determine whether the document captured by user 202 is the requested document. If the user is attempting to upload an incorrect document, it may indicate confusion as to the instructions provided, and additional clarifications can be provided. One of skill in the art will appreciate that a variety of other sensors can be employed in embodiments of the invention. All types of sensors, now known or later developed, are contemplated as being usable in embodiments of the invention.

Turning now to FIG. 3, a flowchart illustrating the operation of a method in accordance with embodiments of the invention is depicted and referred to generally by reference numeral 300. Initially, at step 302, a subtask is determined and presented on a computing device such as mobile device 204 to a user such as user 202. Broadly speaking, the subtask can be any subcomponent of a complex task. For example, if the complex task is completing a tax return, then one subtask might be providing (e.g., scanning and uploading) an individual tax document, answering a question (or series of related questions), or providing credentials to access an online repository of tax documents. If the complex task is to replace a tire, then the sub tasks might include loosening and removing the lug nuts, removing the old tire, mounting the new tire, and replacing and tightening the lug nuts. One of skill in the art will appreciate that these tasks and subtasks are merely examples, and embodiments of the invention can be employed with any task to be performed by the user.

Processing can then proceed to step 304, where a difficulty the user is having the subtask is recognized based on data from one or more sensors 212 of mobile device 204. Many types of difficulty can be recognized, and data from many types of sensors can be employed in recognizing it. For example, if the app on mobile device 204 is providing a checklist of documents, then front-facing camera 224 might determine that the user's gaze has been fixed on the checklist for an extended period of time, or that the user has been reading and rereading the same portion of the instructions. This may indicate that the user is confused or unclear about the instructions provided.

Alternatively, the difficulty may be that the given subtask is difficult to complete under the current circumstances. For example, if accelerometer 222 indicates that mobile device 204 is shaking or otherwise moving irregularly (e.g., because the user is in a moving vehicle), then tasks such as photographing a document or using a stylus to execute a digital signature will be more difficult then if the user is sitting at a desk. Similarly, if accelerometer 222 in combination with a gait-recognition algorithm indicates that the user is walking, then it may be difficult to read complex instructions in fine print, and if location-determining component 214 indicates that the user is away from home, then they may not have access to tax documents to upload at the current time.

As another alternative, the sensors 212 can detect user sentiment, as described in greater detail above. For example, front-facing camera 224 might capture an image of the user's face, and mood-detection algorithms can determine that the user is relaxed, concentrating, angry, frustrated, upset, and so on. Other sensors can also collect data usable to determine user sentiment. For example, accelerometer 222 might detect that the user is shaking mobile device 204, which could be interpreted as a sign of anger or frustration. Similarly, a pressure-sensitive touch screen could detect that the user is tapping the screen more aggressively to control the app, which might also be interpreted as a sign of anger or frustration.

When the system detects a difficulty with the subtask, processing can proceed to step 306, where the system can remediate the difficulty detected. As described above, the system can detect a wide variety of difficulties, and different difficulties can be remediated differently. For example, if the user is confused by a set of instructions for the subtask, additional explanation can be provided or the subtask can be broken down into a series of smaller subtasks. Alternatively, the user can be prompted to determine if they would like to speak to an agent in order to resolve the difficulty, or the agent can affirmatively reach out to the user to ask if they need help. Each type of difficulty may be remediated differently, and a particular type of difficulty might have multiple remediation strategies that are appropriate in different circumstances.

In some embodiments, if it is the current circumstances that are creating the difficulty, the current subtask can be modified or postponed until the circumstances are more congenial. For example, instead of prompting the user to take a picture of a document if they are away from home, the system could instead inform the user that the document will need to be uploaded, and ask if they would like to be reminded to upload it the next time they are home. In some embodiments, the user can simply be warned of a difficulty that may be non-obvious. For example, if the user is attempting to capture an image of a document while in a moving vehicle, they might be warned of the likelihood of taking a blurred image in order to avoid the need to retake the image later. One of skill in the art will appreciate that difficulties can be remediated in a variety of ways, and a variety of techniques for addressing user difficulties are envisioned as being within the scope of the invention.

Many different arrangements of the various components depicted, as well as components not shown, are possible without departing from the scope of the claims below. Embodiments of the invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims. Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. One or more computer-storage media storing computer-executable instructions that, when executed by a processor, perform a method of assisting a user with a complex task, the method comprising the steps of:
determining a subtask of a complex task for the user to complete;
presenting the subtask to the user on a smartphone;
receiving input from one or more sensors incorporated into the smartphone;
determining, on the basis of the input form the one or more sensors, a sentiment of the user;
based at least on the sentiment of the user, automatically connecting the user with an agent to assist the user with the subtask.

2. The media of claim 1, wherein the complex task is completing a tax interview.

3. The media of claim 1, wherein the subtask is capturing an image of a document using a camera integrated into the smartphone.

4. The media of claim 1, further comprising the step of prompting the user prior to automatically connecting the user with the agent.

5. The media of claim 1, wherein the sensor is a front-facing camera and the user sentiment is a state of user confusion.

6. The media of claim 1, wherein the sensor is an accelerometer.

7. The media of claim 1, wherein the sensor is a GPS receiver.

8. A method of assisting a user with a complex task, comprising the steps of:
presenting, to the user and on a mobile device associated with the user, an indication of a subtask of the complex task;
receiving, from a sensor communicatively coupled to the mobile device, data about the user;
determining, based on the data about the user, a sentiment of user while performing the subtask;
based at least in part on the sentiment of the user, providing the user with additional guidance in completing the subtask.

9. The method of claim 8, wherein the mobile device is a tablet computer.

10. The method of claim 8, wherein the guidance is provided by an agent speaking to the user.

11. The method of claim 8, wherein the sensor is a front-facing camera and the user sentiment is a state of user frustration.

12. The method of claim 8, wherein the subtask is responding to a series of questions.

13. The method of claim 8, wherein the sensor is a biometric sensor.

14. The method of claim 8, wherein the additional guidance is an expanded explanation of instructions for carrying out the subtask.

15. The method of claim 8, wherein the sensor is a GPS receiver and the subtask is capturing an image of a document.

16. A system for assisting a user in completing a complex tax, comprising:
a server; and
a mobile device of the user, wherein the mobile device incorporates a sensor configured to gather data about the user and wherein the mobile device is programmed to:
present a subtask of a complex task to the user;
receive data from the sensor about the user;
transmit the data received from the sensor to the server;
wherein the server is programmed to:
receive the data received from the sensor from the mobile device;
determine, based at least in part on the data received from the sensor, a sentiment for the user while performing the subtask; and
automatically establish, via the mobile device, communication between the user and an agent tasked with assisting the user with the complex task.

17. The system of claim 16, wherein the communication established between the use and the agent is voice communication.

18. The system of claim 16, wherein the sensor is a microphone.

19. The system of claim 16, wherein the sensor is a light sensor.

20. The system of claim 16, wherein the subtask is reviewing instructions.
